(19) United States
(12) Patent Application Publication
(10) Pub. No.: US 2016/0280397 A1
(43) Pub. Date: Sep. 29, 2016

(54) METHOD AND SYSTEM TO AVOID PLANT SHADOWS FOR VEGETATION AND SOIL IMAGING

(71) Applicant: Konica Minolta Laboratory U.S.A., Inc., San Mateo, CA (US)

(72) Inventors: John Randall CHRIST, Santa Clara, CA (US); Po-Chieh HUNG, Cupertino, CA (US)

(73) Assignee: Konica Minolta Laboratory U.S.A., Inc., San Mateo, CA (US)

(21) Appl. No.: 15/081,482

(22) Filed: Mar. 25, 2016

Related U.S. Application Data
(60) Provisional application No. 62/139,519, filed on Mar. 27, 2015.

(51) Int. Cl. B64D 47/08; G01S 19/13; H04N 5/247; H04N 5/232; G06T 7/00

(52) U.S. Cl. CPC B64D 47/08; H04N 5/23216; G06T 7/0004; G06T 7/0042; H04N 5/247; G01S 19/13; G06T 2207/10016; G06T 2207/30128; G06T 2207/10032

(57) ABSTRACT

A method, a computer program product, and a system is disclosed of obtaining aerial images from an aerial vehicle to avoid shadows produced by the sun, the method comprising: providing the aerial vehicle with one or more cameras configured to capture images of a landscape; and arranging the one or more cameras to capture the images from an angle which is opposite in direction of the sun.

### CROSS-REFERENCES TO RELATED APPLICATIONS

This application claims priority to U.S. Provisional Patent Application Ser. No. 62/139,519, filed on Mar. 27, 2015, the entire content of which is incorporated herein by reference.

### FIELD

The present application relates to a method and system to avoid plant shadows for vegetation and soil imaging, and more particularly, to a method and system to avoid and/or reduce plant shadowing for vegetation and soil imaging from an aerial vehicle using one or more cameras and obtaining images based on a location of the sun relative to the aerial vehicle and, for example, plants and/or vegetation.

### BACKGROUND

Aerial vehicles can include manned airplanes, rotary type unmanned aerial vehicles (UAV) including helicopters, quadcopters, hexacopters, octocopters, and/or fixed wing UAVs can be used to obtain aerial photographs. While capturing the images, shadowing of plant leaves on nearby crop plants and soil can reduce accuracy of remote sensing. In addition, for example, the problem can be worse with high resolution low elevation remote sensing.

### SUMMARY

In consideration of the above issues, it would be desirable to have a method and system to help avoid and/or reduce plant shadows for vegetation and soil imaging.

In accordance with an exemplary embodiment, a method is disclosed of obtaining aerial images from an aerial vehicle to avoid shadows produced by the sun, the method comprising: providing the aerial vehicle with one or more cameras configured to capture images of a landscape; and arranging the one or more cameras to capture the images from an angle which is opposite in direction of the sun.

In accordance with an exemplary embodiment, a computer program product comprising a non-transitory computer readable medium having a computer readable code embodied therein for obtaining aerial images from an aerial vehicle which avoids shadows produced by the sun is disclosed, the computer readable program code configured to execute a process, which includes the steps of: providing the aerial vehicle with one or more cameras configured to capture images of a landscape; and arranging the one or more cameras to capture the images from an angle which is opposite in direction of the sun.

In accordance with an exemplary embodiment, a system of obtaining aerial images from an aerial vehicle to avoid shadows produced by the sun, the system comprising: an aerial vehicle with one or more cameras configured to capture images of a landscape, and wherein the one or more cameras are arranged to capture the images from an angle which is opposite in direction of the sun.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is an illustration of an aerial vehicle having dual cameras, and wherein the aerial vehicle is flying away from the direction of the sun in accordance with an exemplary embodiment;

FIG. 1B is an illustration of an aerial vehicle having dual cameras, and wherein the aerial vehicle is flying towards or into the direction of the sun in accordance with an exemplary embodiment;

FIG. 2 is an illustration of an aerial vehicle having a fixed camera, and wherein the fixed camera captures images when flying in an opposite direction (or away) from the sun in accordance with an exemplary embodiment;

FIG. 3A is an illustration of an aerial vehicle having a gimbal mount, and wherein the aerial vehicle is flying away from direction of the sun in accordance with an exemplary embodiment;

FIG. 3B is an illustration of an aerial vehicle having a gimbal mount, and wherein the aerial vehicle is flying towards the direction of the sun in accordance with an exemplary embodiment;

FIG. 4A is an illustration of an aerial vehicle having fixed camera with a tilted and/or shifted lens, and wherein the aerial vehicle is flying away from the direction of the sun in accordance with an exemplary embodiment;

FIG. 4B is an illustration of an aerial vehicle having fixed camera with a tilted and/or shifted lens, and wherein the aerial vehicle is flying towards the sun in accordance with an exemplary embodiment;

FIG. 5 is an illustration of an aerial vehicle having camera with a digital image adjustment in accordance with an exemplary embodiment;

FIG. 6 is an illustration of an aerial vehicle and an aerial vehicle shadow to determine sun direction in accordance with an exemplary embodiment;

FIG. 7 is an illustration of an aerial vehicle and camera direction based on sun direction in accordance with an exemplary embodiment;

FIG. 8 is an illustration of the use of bands to avoid the area of an image containing the aerial vehicle shadow; and

FIG. 9 is an illustration of the use of multiple views of a leaf to obtain the size of the leaf by removing the shadows on the sides of the leaf.

### DESCRIPTION OF THE PREFERRED EMBODIMENTS

Shadows can reduce the accuracy of vegetation and soil remote sensing. For example, in accordance with an exemplary embodiment, adjustments can be made to the camera angle such that the camera angle is opposite to the sun direction to help reduce shadows. In accordance with an exemplary embodiment, by detecting the direction of the sun, one can help reduce the effects of shadows in aerial photographs. The direction of the sun can be detected by using the shadow direction of an aerial vehicle, or data including information obtained from GPS including time, date, and geographical location. In addition, it can be desirable to detect shadows on lower edge of plants closest to an optical axis, and/or luminance or near infrared bands, which can help improve detection of shadows.

In accordance with an exemplary embodiment, a method and system is disclosed, which can improve accuracy of vegetation and soil imaging by reducing shadows on the images. In addition, the method and system as disclosed can reduce the time consuming post processing needed to remove shadowing over existing methods.

In accordance with an exemplary embodiment, the method and system as disclosed can determine sun direction using, for example, a direction of an aerial vehicle shadow and/or combination of GPS geographic location, date and time. In accordance with an exemplary embodiment, the camera can be oriented, or a flight direction of the aerial vehicle can be changed such that the camera can be oriented opposite to the sun direction, which can help minimize plant shadows on neighboring vegetation and soil.

In accordance with an exemplary embodiment, near infrared and luminance can be utilized to improve detection of residual shadows. In accordance with an exemplary embodiment, for example, healthy vegetation can reflect near infrared, however shadows reflect near infrared much less, especially, for example, if shadows are on the ground. Healthy vegetation can also be brighter than shadows, allowing luminance to differentiate between shadows and healthy vegetation. In addition, the side of a shadow can be seen towards the opposite direction of the sun (shadow of aerial vehicle), which characteristics can be used for accurate shadow detection.

In accordance with an exemplary embodiment, the direction of the sun can be determined by detection of the aerial vehicle shadow using several consecutive image frames. As the result, objects on the ground will be blurry while the shadow is almost the same. In accordance with an exemplary embodiment, removal of aerial vehicle shadow can be accomplished by replacing aerial vehicle shadow pixels of frame with subsequent frames containing non-shadow pixels, which can be performed using an image processing method. For example, in accordance with an exemplary embodiment, once the aerial vehicle shadow position is detected, the portion of image on both sides of the detected shadow can be extracted as bands and the area of the image containing the aerial vehicle shadow can be avoided to eliminate effect of aerial vehicle shadow. However, to detect actual area of plant leaves, images taken toward the sun angle and away from the sun angle can be combined to form an image with minimal shadows on either side, which procedure allows more accurate vegetation analysis by analyzing only the leaf itself and not the leaf's shadow.

In accordance with an exemplary embodiment, the method and system as disclosed can avoid shadows by adjusting the camera angle to point in a direction opposite to the sun.

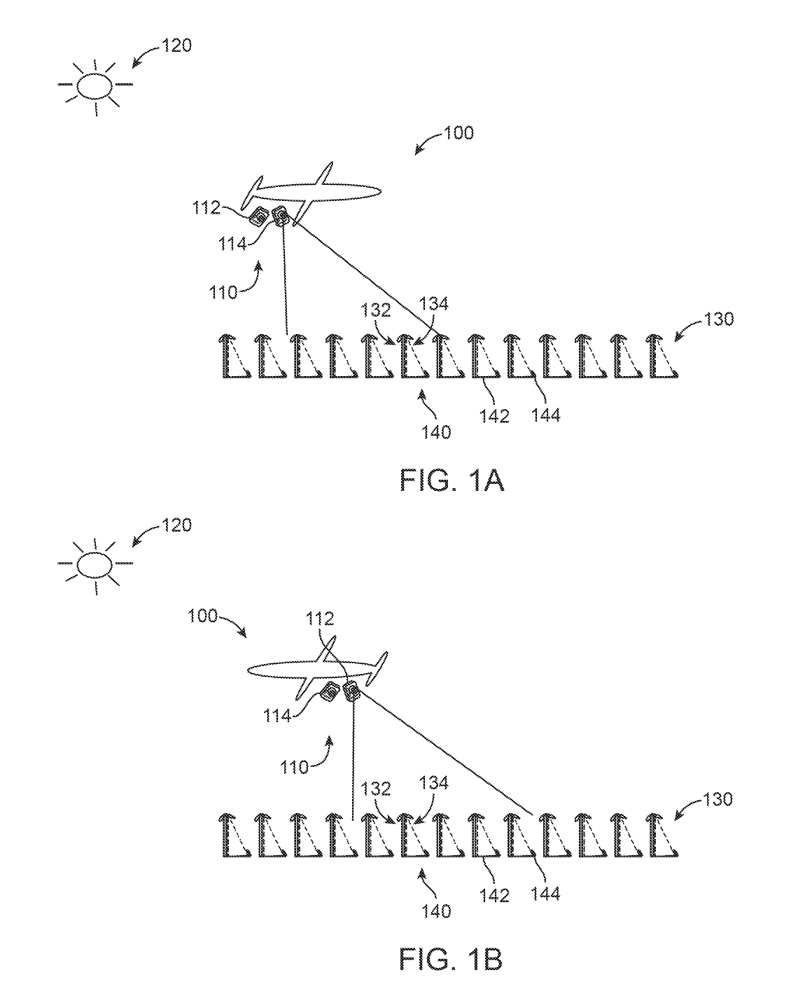

In accordance with an exemplary embodiment, the method and system as disclosed can use dual cameras 110, which can include a first camera 114 pointing towards the front of the aerial vehicle 100 and a second camera 112 pointing behind the aerial vehicle as shown in FIGS. 1A and 1B, respectively. In accordance with an exemplary embodiment, this method can have the advantage, for example, of being mechanically simple, however the use of two cameras can have added weight, and the cost for two camera sensors and lenses may be higher. In addition, the use of dual cameras can avoid complicated mechanical systems.

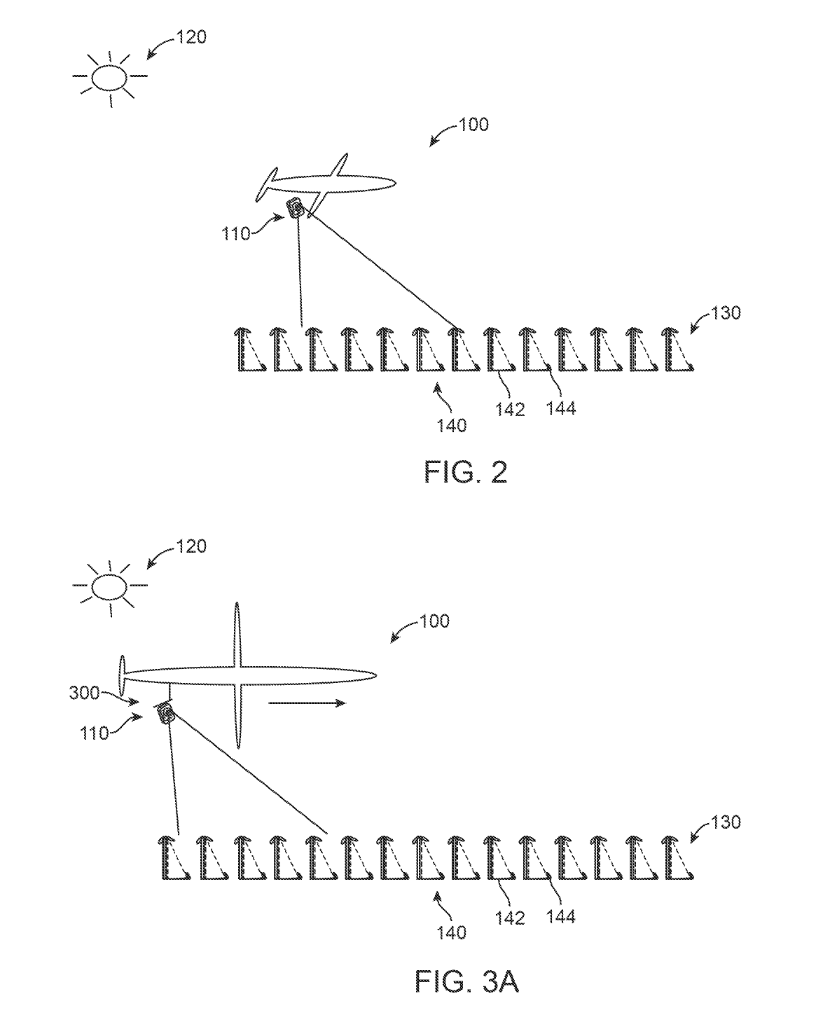

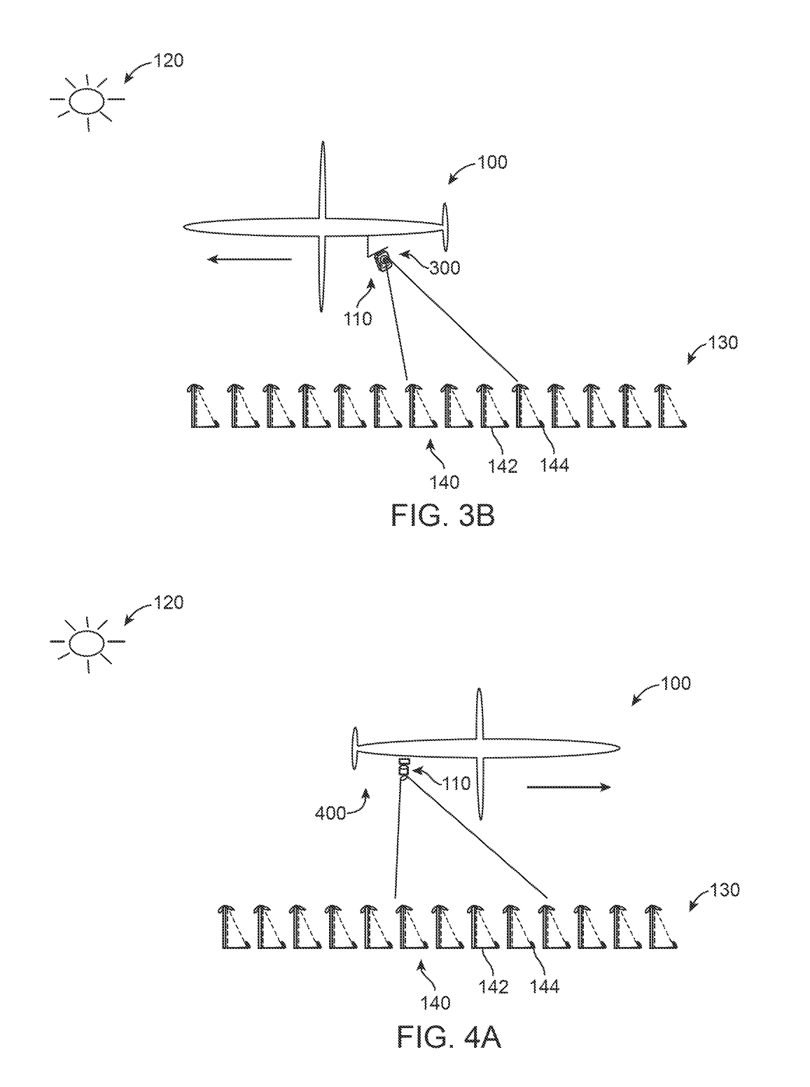

In accordance with an exemplary embodiment, the method and system as disclosed can use gimbal camera mount 300 as shown in FIGS. 3A and 3B. In accordance with an exemplary embodiment, full sensor resolution can be utilized at the expense of increased weight and mechanical complexity.

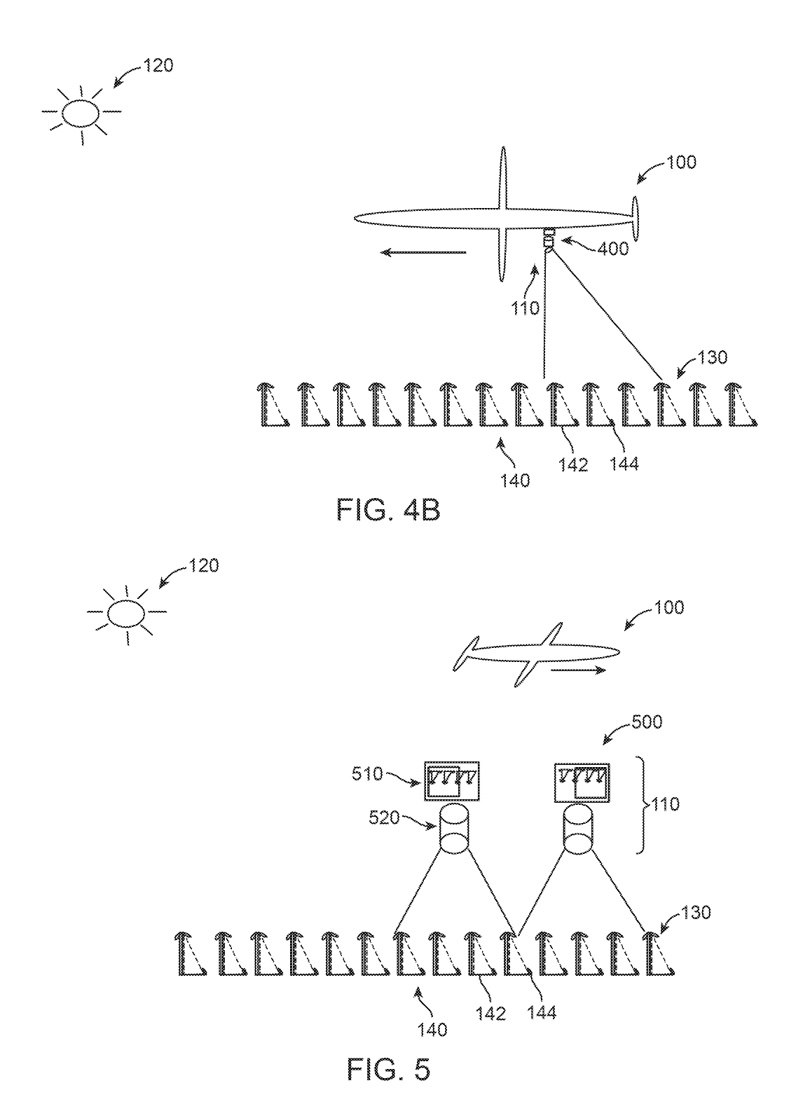

In accordance with an exemplary embodiment, the method and system as disclosed can use a camera 110 having a tilted and/or shifted lens as shown in FIGS. 4A and 4B. In accordance with an exemplary embodiment, the advantage of using a tilt/shift lens instead of digitally processing the position of the pixels on the sensor can be that the full resolution of the sensor is utilized for imaging at the expense of increased mechanical complexity and heavier weight.

In accordance with an exemplary embodiment, the method and system as disclosed can use a digital image adjustment by adjusting utilized pixel locations on sensor as shown in FIG. 5, which can have the advantage of being lighter weight, at the expense of utilization of portions of the image sensor for image adjustment, and which can reduce available spatial resolution. In accordance with an exemplary embodiment, the optical axis of camera can be adjusted to the perpendicular of the ground.

In accordance with an exemplary embodiment, the method and system as disclosed can use a digital image processing using a morphing technique, which can include the optical axis of camera being adjustable to a direction, which is opposite of the sun.

In accordance with an exemplary embodiment, the method and system as disclosed can use sun direction detection methods, which can include the use of the GPS geographical location of the aerial vehicle, time and date of captured image.

As shown in FIG. 1A, an aerial vehicle 100 having one or more cameras 110, for example, two or more cameras (or dual cameras) 112, 114, and wherein the aerial vehicle 100 is flying away from the direction of the sun 120 and sunlight and/or electromagnetic radiation given off by the sun in accordance with an exemplary embodiment. As shown in FIG. 1A, the one or more cameras 110 on the aerial vehicle 100 can include one camera 112 pointing towards the back or aft of the aerial vehicle 100 and another camera 114 pointing towards the front or forward portion of the aerial vehicle 100. In accordance with an exemplary embodiment, when the aerial vehicle 100 is flying away from the sun, the camera 114 pointing forward would be activated (or “on”), which would capture a front side 132 of the plants (or vegetation) 130 with a shadow 140 on a backside 134 of the plants (or vegetation) 130. The shadow 140 on the backside 134 of the plants (or vegetation) 130, for example, can include a plant stalk shadow 142 and a plant leaf shadow 144. In addition, the camera 112 pointing towards the back of the aerial vehicle can be in a non-activated state (or “off”).

FIG. 1B is an illustration of an aerial vehicle 100 having one or more cameras 110, for example, dual cameras 112, 114, and wherein the aerial vehicle 100 is flying towards or into the direction of the sun 120 in accordance with an exemplary embodiment. As shown in FIG. 1B, when the aerial vehicle 100 is flying towards the sun 120, the camera 114 pointing forward would be in a non-activated state or “Off,” and the camera 112 pointing towards the back (or tail) of the aerial vehicle 100 would be activated or “on.”

FIG. 2 is an illustration of an aerial vehicle 100 having a fixed camera 110, and wherein the fixed camera 110 captures images only when only flying in an opposite direction or away from the sun. As shown in FIG. 2, the camera 110 can be fixed, such that the camera 110 faces forward and can capture images only when flying away from the sun 120. Alternatively, in accordance with an exemplary embodiment, the camera can be fixed to face toward the rear or tail of the aerial vehicle 100 and can capture image only when flying towards or into the sun 120.

FIG. 3A is an illustration of an aerial vehicle 100 having a rotatable mount 300, for example, a gimbal mount, and wherein the aerial vehicle 100 is flying away from direction of the sun 120 in accordance with an exemplary embodiment. In accordance with an exemplary embodiment, the rotatable mount 300 can be any type of mount that pivotally supports a camera 110 and allows rotation of the camera about an axis, for example, a single axis. As shown in FIG. 3A, when the aerial vehicle 100 is flying away from the sun 120, the camera 110 preferably points forward to capture an image of the front side 132 of the plants and/or vegetation 130.

FIG. 3B is an illustration of an aerial vehicle 100 having a rotatable mount 300, for example, a gimbal mount, and wherein the aerial vehicle is flying towards the direction of the sun 120 in accordance with an exemplary embodiment. As shown in FIG. 3B, when the aerial vehicle 100 is flying into or towards the sun, the camera 110 will face towards the rear or aft of the aerial vehicle to capture images of the plants and/or vegetation 130.

FIG. 4A is an illustration of an aerial vehicle 100 having a camera 110, which can be fixed, with a tilted and/or shifted lens 400, and wherein the aerial vehicle 100 is flying away from the direction of the sun 120 in accordance with an exemplary embodiment. As shown in FIG. 4A, the tilted and/or shifted lens 400 of the camera 110 is pointed away from the sun 120, for example, towards the front of the aerial vehicle 100. In accordance with an exemplary embodiment, the tilted and/or shifted lens 400 can optically be used to capture large depth of field in an image.

In accordance with an exemplary embodiment, tilt and shift can encompass two different types of movements, which include rotation of the lens plane relative to the image plane, or tilt, and movement of the lens parallel to the image plane, or shift. Tilt can be used to control the orientation of the plane of focus (PoF), and hence the part of an image that appears sharp, which makes use of the Scheimpflug principle. Shift can be used to adjust the position of the subject in the image area without moving the camera back, which can be helpful in avoiding the convergence of parallel lines, as when photographing tall buildings.

FIG. 4B is an illustration of an aerial vehicle 100 having camera 110 with a tilted and/or shifted lens 400, and wherein the aerial vehicle 100 is flying towards the sun 120 in accordance with an exemplary embodiment. As shown in FIG. 4B, the tilted and/or shifted lens is pointing away from the sun 120, for example, towards the backend or tail end of the aerial vehicle 100.

FIG. 5 is an illustration of an aerial vehicle 100 having camera 110 with a digital image adjustment 500 in accordance with an exemplary embodiment. As shown in FIG. 5, camera 110 having a digital image adjustment 500 can include an image sensor 510 and a lens stack 520, wherein the digital image obtained by the camera 110 can be adjusted by adjusting utilized pixel location on the sensor. For example, in accordance with an exemplary embodiment, a first sensor area can be used when moving the image towards the front of the aerial vehicle 100, and a second sensor area can be used when moving the image towards the tail or back of the aerial vehicle 100.

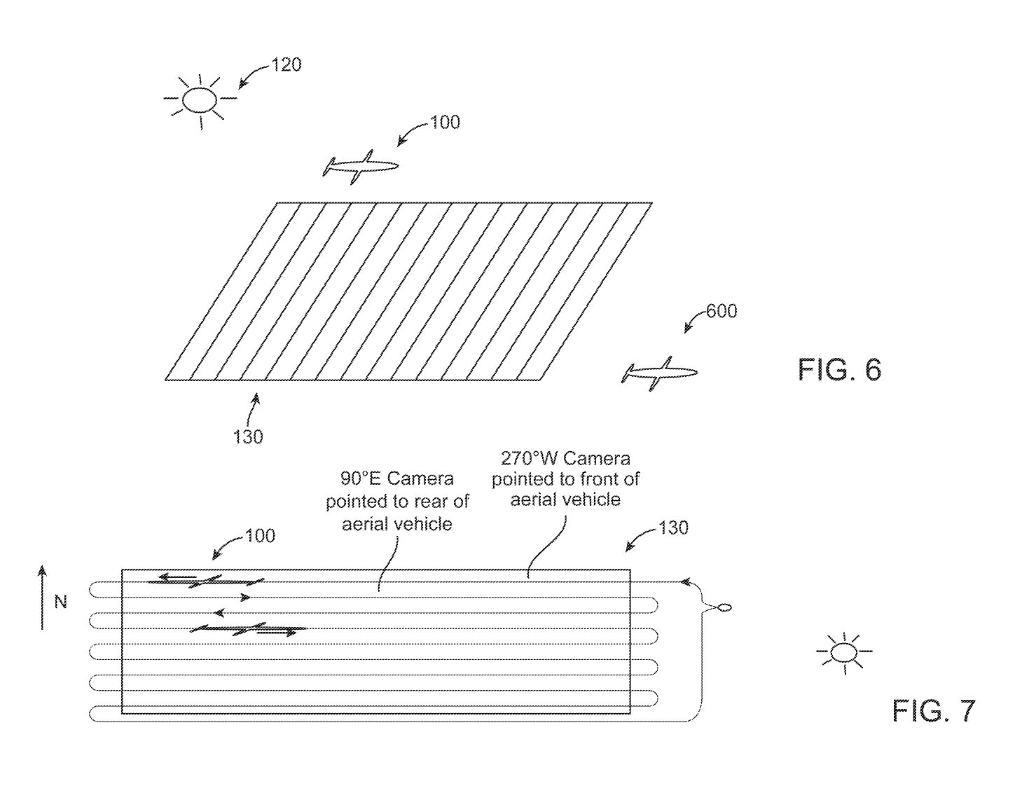

FIG. 6 is an illustration of an aerial vehicle and an aerial vehicle shadow to determine sun direction in accordance with an exemplary embodiment. As shown in FIG. 6, the aerial vehicle shadow 600 can be detected using consecutive frames with motion detection algorithms. The aerial vehicle shadow 600 can then be removed using pixel replacement methods. In accordance with an exemplary embodiment, the removed pixel can be filled by other images taken at a different timing. Once the aerial vehicle shadow 600 is detected, aerial vehicle yaw, pitch and roll angle can be used to calculate offset of shadow from a position of the aerial vehicle 100. In addition, the camera angle can also be used to determine the angle of the shadow 600 from the position of the aerial vehicle 100. Once the aerial vehicle shadow offset is calculated, the sun position can then be calculated using trigonometric methods.

In accordance with an exemplary embodiment, the method and system as disclosed can adjust the camera angle based on an angle of the sun 120. For example, in accordance with an exemplary embodiment, the camera adjustment can be adjusted to be opposite the direction of the sun. For example, assume the aerial vehicle is flying on a course of 270° W. The flight is taking place over northern Iowa on Jun. 4, 2015 at 10:00 AM. The GPS locations from the aerial vehicle navigation system are latitude 43.2932, longitude −92.680664. The sun azimuth angle is determined to be 102.65° and the sun elevation angle is 45.93° using parameters of GPS coordinates of the flight area and the date and time of the flight inputted into online sun position calculators such as that provided by the National Oceanic and Atmospheric Administration (http://www.esrl.noaa.gov/gmd/grad/solcalc/) or using the position and length of the aerial vehicle shadow. Based on this information, in accordance with an exemplary embodiment, the camera angle would be pointed towards the front of the aerial vehicle 100 since the sun direction is behind the aerial vehicle on the port side at an approximate angle, for example, of 13°.

In accordance with an exemplary embodiment, when imaging, for example, an agricultural field, the aerial vehicle 100 can traverse the field multiple times to image the entire field, using various methods such as a racetrack or lawnmower pattern as shown in FIG. 7. The home position shown on FIG. 7 represents the ground location where the aerial vehicle 100 takes off and lands. The aerial vehicle figures in FIG. 7 represent the direction that the aerial vehicle is flying. In accordance with an exemplary embodiment, imaging the entire field can require the aerial vehicle to make a 180° turn at the end of the field and fly over the field in the opposite direction.

For this example, the aerial vehicle 100 flight direction for the opposite lawnmower pattern, the camera 110 would be pointed behind the aerial vehicle 100, approximately opposite to the sun 120 direction to minimize the effect of crop shadows on the images.

In accordance with an exemplary embodiment, images from one or more cameras 110 can be stitched or processed together for vegetation and soil imaging. For example, images can be obtained by one or more of the above disclosed methods using one or more fixed cameras 110, dual cameras 112, 114, a gimbal mount 300 and/or a tilted and shifted lens 400 and obtaining images from the aerial vehicle 100, which are taken from a non-shadow side and assembled together such that as the aerial vehicle 100 travels along a direction, one or more overlapping images can be obtained and assembled to reduce the shadows within the assembled image.

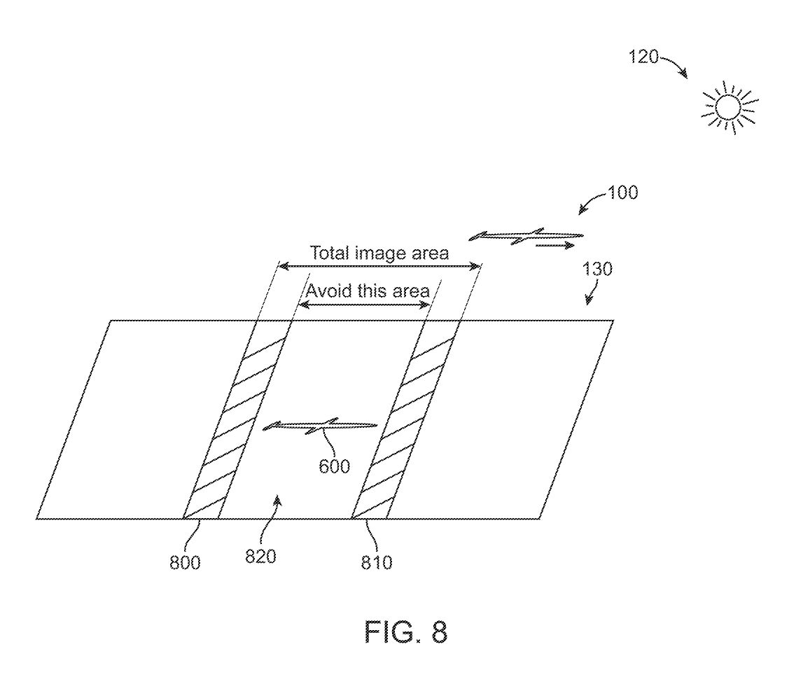

FIG. 8 illustrates the use bands 800, 810 to avoid an area (or portion) 820 of an image containing the shadow 600 of an aerial vehicle 100. As shown in FIG. 8, for example, the image may contain the shadow 600 from the aerial vehicle 100. In order to avoid the shadow 600, a portion 820 of each image containing the shadow 600 can be discarded and/or not used during the assembly of the images for vegetation and soil imaging. In addition, one or more bands (or regions) 800, 810 of the image, which do not include a portion 820 of the shadow 600 of the aerial vehicle 100 can be used and assembled.

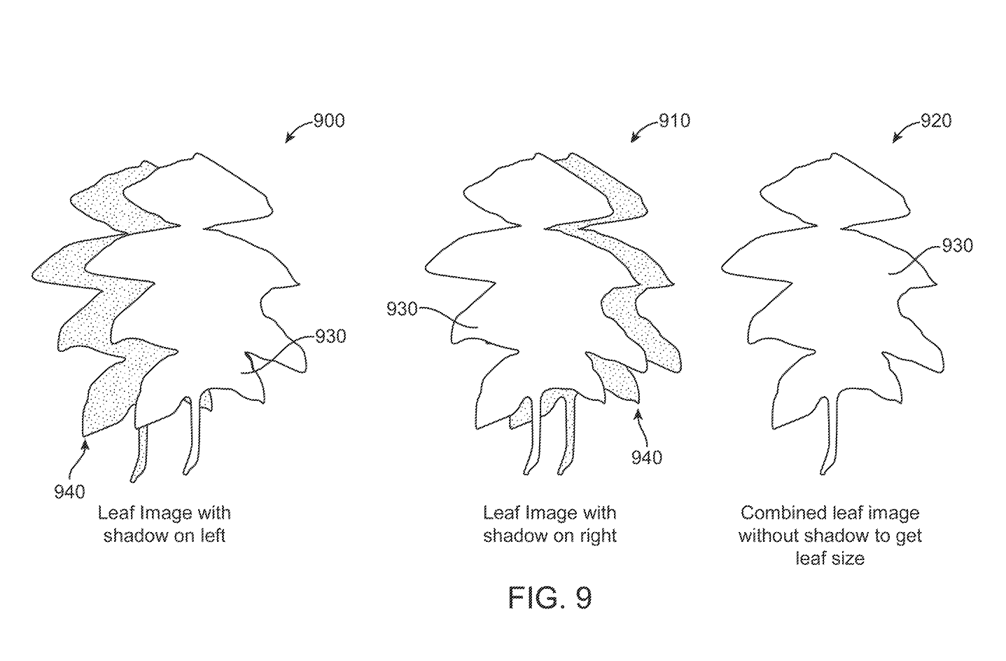

FIG. 9 illustrates the use of multiple views of a leaf 900, 910, 920 to obtain the size of the leaf by removing the shadows on the sides of the leaf. As shown in FIG. 9, leaf image 900 illustrates a leaf 930 with a shadow 940 on a left side of the leaf 930. Leaf image 910 illustrates a leaf 930 with a shadow 940 on a right side of the leaf 930. Leaf image 920 illustrates the leaf 930, wherein the two images from images 900, 910 of the leaf 930 can be combined to remove the shadow 940 and obtain the size of the leaf 930 without a shadow on either the right and/or left side of the image. In accordance with an exemplary embodiment, the image 930 of the leaf 920 can be generated by assembling the two or more images 900, 910.

In accordance with an exemplary embodiment, a computer program product comprising a non-transitory computer readable medium having a computer readable code embodied therein for obtaining aerial images from an aerial vehicle which avoids shadows produced by the sun is disclosed, the computer readable program code configured to execute a process, which includes the steps of: providing the aerial vehicle with one or more cameras configured to capture images of a landscape; and arranging the one or more cameras to capture the images from an angle which is opposite in direction of the sun.

The non-transitory computer usable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

The present invention includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”.

In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure.

In this disclosure and during the prosecution of this application, the terminology “embodiment” can be used to describe any aspect, feature, process or step, any combination thereof, and/or any portion thereof, etc. In some examples, various embodiments may include overlapping features.

What is claimed is:

1. A method of obtaining aerial images from an aerial vehicle to avoid shadows produced by the sun, the method comprising:
providing the aerial vehicle with one or more cameras configured to capture images of a landscape; and
arranging the one or more cameras to capture the images from an angle which is opposite in direction of the sun.

2. The method of claim 1, wherein the one or more cameras include a pair of fixed cameras, which are arranged such that a first camera points toward a front of the aerial vehicle and a second camera points towards a back end of the aerial vehicle;
operating the first camera pointing towards the front of the aerial vehicle when flying away from the sun; and
operating the second camera pointing towards the back end of the aerial vehicle when flying into the sun.

3. The method of claim 1, wherein the one or more cameras include a rotatable camera mounted on an adjustable axis; and
adjusting the rotatable camera to capture the images from the angle which is opposite in direction of the sun.

4. The method of claim 3, comprising:
adjusting the rotatable camera based on the location of the sun using a Global Positioning System (GPS).

5. The method of claim 1, comprising;
determining a location of the sun based on detection of a shadow of the aerial vehicle.

6. The method of claim 1, wherein the one or more cameras includes a tilted lens and/or a shifted lens camera.

7. The method of claim 1, comprising:
adjusting a digital image of the image captured by the camera using a sensor, and
adjusting the digital image of the captured image to be perpendicular to the landscape.

8. The method of claim 1, comprising:
capturing a plurality of images; and
assembling the plurality of images taken from a non-shadow side of the landscape.

9. The method of claim 1, comprising:
monitoring the landscape for growth of plants and/or vegetation in an agricultural field.

10. A computer program product comprising a non-transitory computer readable medium having a computer readable code embodied therein for obtaining aerial images from an aerial vehicle which avoids shadows produced by the sun, the computer readable program code configured to execute a process, which includes the steps of:
providing the aerial vehicle with one or more cameras configured to capture images of a landscape; and
arranging the one or more cameras to capture the images from an angle which is opposite in direction of the sun.

11. The computer program product of claim 10, wherein the one or more cameras include a pair of fixed cameras, which are arranged such that a first camera points toward a front of the aerial vehicle and a second camera points towards a back end of the aerial vehicle;
operating the first camera pointing towards the front of the aerial vehicle when flying away from the sun; and
operating the second camera pointing towards the back end of the aerial vehicle when flying into the sun.

12. The computer program product of claim 10, wherein the one or more cameras include a rotatable camera mounted on an adjustable axis; and
adjusting the rotatable camera to capture the images from the angle which is opposite in direction of the sun.

13. The computer program product of claim 12, comprising:
adjusting the rotatable camera based on the location of the sun using a Global Positioning System (GPS).

14. The computer program product of claim 10, comprising one or more of the following;
determining a location of the sun based on detection of a shadow of the aerial vehicle;
wherein the one or more cameras includes a tilted lens and/or a shifted lens camera;
adjusting a digital image of the image captured by the camera using a sensor, and adjusting the digital image of the captured image to be perpendicular to the landscape; and
capturing a plurality of images, and assembling the plurality of images taken from a non-shadow side of the landscape.

15. A system of obtaining aerial images from an aerial vehicle to avoid shadows produced by the sun, the system comprising:
an aerial vehicle with one or more cameras configured to capture images of a landscape, and wherein the one or more cameras are arranged to capture the images from an angle which is opposite in direction of the sun.

16. The system of claim 15, wherein the one or more cameras include a pair of fixed cameras, which are arranged such that a first camera points toward a front of the aerial vehicle and a second camera points towards a back end of the aerial vehicle;
the first camera pointing towards the front of the aerial vehicle operating when flying away from the sun; and
the second camera pointing towards the back end of the aerial vehicle operating when flying into the sun.

17. The system of claim 15, wherein the one or more cameras include a rotatable camera mounted on an adjustable axis; and
the rotatable camera is adjusted to capture the images from the angle which is opposite in direction of the sun.

18. The system of claim 15, wherein the rotatable camera is adjusted based on the location of the sun using a Global Positioning System (GPS).

19. The system of claim 15, comprising one or more of the following;
wherein a location of the sun is determined based on detection of a shadow of the aerial vehicle;
wherein the one or more cameras includes a tilted lens and/or a shifted lens camera; and
a sensor for adjusting a digital image of the image captured by the camera, and wherein the digital image of the captured image is adjusted to a perpendicular of the landscape.

20. The system of claim 15, wherein the one or more cameras capture a plurality of images, and assembling the plurality of images taken from a non-shadow side of the landscape.
